(19) United States
(12) Patent Application Publication
(10) Pub. No.: US 2008/0217296 A1
(43) Pub. Date: Sep. 11, 2008

(54) ETCHING APPARATUS FOR SEMICONDUCTOR PROCESSING APPARATUS AND METHOD THEREOF FOR RECYCLING ETCHANT SOLUTIONS

(75) Inventors: Son-Lung Chen, Pingtung County (TW); Ying-Fang Chen, Taichung City (TW); I-Yao Chen, Tainan County (TW); Kuo-Chang Chu, Kaohsiung County (TW); Guo-Qiang Wu, Taoyuan County (TW)

Correspondence Address: J C PATENTS, INC., 4 VENTURE, SUITE 250, IRVINE, CA, 92618, US

(73) Assignee: UNITED MICROELECTRONICS CORP., Hsinchu (TW)

(21) Appl. No.: 11/683,039

(22) Filed: Mar. 7, 2007

(51) Int. Cl. C23F 1/00; B44C 1/22

(52) U.S. Cl. 216/93; 156/345.18

(57) ABSTRACT

An etching apparatus of a semiconductor processing apparatus and the method thereof for recycling etchant solutions are provided. The method is suitable for a processing apparatus which provides an etchant solution on a wafer so as to perform an etching process. After the etching process is completed, a water solution is added to the etchant solution for maintaining a water content thereof. Then, the mixed etchant solution is recycled.

### BACKGROUND OF THE INVENTION

1. Field of the Invention

The present invention relates to a semiconductor manufacturing process and a semiconductor apparatus, and more particularly, to an etching apparatus and the method thereof for recycling etchant solutions.

2. Description of Related Art

In a semiconductor manufacturing process, the principle of a wet etching process is to generate a chemical reaction between a thin film and an etchant solution, so as to remove parts of the thin film uncovered or unprotected by a photoresist layer or a mask layer. Thereby, mask patterns are successfully transferred to the thin film. It should be noted that the chemical life time of the etchant solution and the manufacturing costs are negatively related. Namely, the longer the chemical life time of the etchant solution is, the lower the manufacturing costs are.

During an etching process, a water content of the etchant solution is reduced because of being evaporated or remaining on a wafer. Thus, the viscosity of the etchant solution is increased as the water content of the etchant solution is decreased, so that the chemical life time of the etchant solution is reduced and the manufacturing costs are increased.

In view of the foregoing, there is a need for a method capable of extending the chemical life time of the etchant solution and of lowering the manufacturing costs.

### SUMMARY OF THE INVENTION

The present invention provides a method for recycling etchant solutions of a semiconductor processing apparatus, adjusting the viscosity of the etchant solutions to a constant level by adding a water solution so as to extend the chemical life time of the etchant solutions and to reduce the manufacturing costs.

The present invention further provides an etching apparatus to adjust the viscosity of the etchant solutions to a constant level by adding a water solution so as to extend the chemical life time of the etchant solutions and to reduce the manufacturing costs.

To accomplish the above and other objectives, the present invention provides a method for recycling etchant solutions of a semiconductor processing apparatus, and the method can be applied to a processing apparatus. The processing apparatus provides an etchant solution and performs an etching process on a wafer. The method for recycling the etchant solution includes the following steps: adding a water solution to the etchant solution for maintaining a water content thereof after the etching process is completed; next, recycling the mixed etchant solution.

In the method for recycling the etchant solution of the semiconductor processing apparatus according to another embodiment of the present invention, the step of adding the water solution to the etchant solution includes adjusting the amount of the water solution based on the water consumed by the wafer during the etching process. The amount of water consumed by the wafer during the etching process is 3.15 cc per wafer, and the water solution is, for example, de-ion water.

According to another embodiment of the present invention, the etchant solution is composed of ATMI ST-250, for example. The process of adding the water solution to the etchant solution for maintaining the water content thereof includes a step of maintaining a weight percentage of water in the etchant solution at 30 wt %˜39% wt, for example.

The step of adding the water solution to the etchant solution according to another embodiment of the present invention further includes determining a reset time of the semiconductor processing apparatus. If the reset time is greater than a predetermined time, it can be deduced that the etching process is completed by the semiconductor processing apparatus. Here, the predetermined time is, for example, 45 seconds.

According to another embodiment of the present invention, the etchant solution is, for example, sprayed on the wafer to perform the etching process with a time lapse of 90 seconds, for example.

According to another embodiment of the present invention, a spin-dry process for removing the residual etchant solution on the wafer is completely carried out after the etching process is completed, and the water solution is added to the etchant solution during the spin-dry process with a time lapse of 5 seconds, for example.

According to another embodiment of the present invention, the semiconductor processing apparatus includes an etching apparatus e.g. model SEZ 4300.

The present invention further provides an etching apparatus including an etching reactor, an etchant solution storage system, and a water solution storage system. The etchant solution storage system is connected to the etching reactor for providing the etchant solution thereto. The water solution storage system connected to the etching reactor actuates the step of adding the water solution to the etchant solution for maintaining a water content thereof when the etchant solution is recycled by the etching apparatus.

According to the etching apparatus disclosed in another embodiment of the present invention, the water solution storage system includes a water solution tank, a pipe, an air valve, and a flow rate controller, for example. The water solution storage tank comprises a water solution e.g. de-ion water. The pipe is connected to the water solution storage tank and the etching reactor so as to introduce the water solution to the etching reactor. The air valve is disposed on the pipe to control a flow time thereof. The flow rate controller is disposed on the pipe to control a flow rate of the water solution. When the etchant solution is recycled by the etching apparatus, the air valve is open for the water solution storage system to add the water solution to the etchant solution.

The step of adding the water solution to the etchant solution according to another embodiment of the present invention includes a step of maintaining a weight percentage of water in the etchant solution at 30 wt %˜39% wt. The etchant solution is composed of ATMI ST-250, for example.

The step of adding the water solution to the etchant solution according to another embodiment of the present invention further includes determining a reset time of the semiconductor processing apparatus. If the reset time is greater than a predetermined time, it can be deduced that the etching process is completed by the semiconductor processing apparatus. The predetermined time is, for example, 45 seconds.

According to another embodiment of the present invention, the etching reactor includes a sucker disposed therein, for example.

According to another embodiment of the present invention, the etching apparatus is model SEZ 4300, for example.

The chemical life time of the etchant solution is mainly determined by the water content of the etchant solution Thus, introducing the water solution to the etchant solution before the etchant solution is recycled can prevent the viscosity of the etchant solution from being increased after each of the etching process is completely performed. This leads to an effective extension of the chemical life time of the etchant solution and reduces the manufacturing costs.

In order to the make the aforementioned and other objects, features and advantages of the present invention comprehensible, a preferred embodiment accompanied with figures are described in detail below.

### BRIEF DESCRIPTION OF THE DRAWINGS

FIG. 1 is a schematic view illustrating an etching apparatus according to an embodiment of the present invention.

FIG. 2 is a flow chart illustrating a method for recycling an etchant solution according to an embodiment of the present invention.

### DESCRIPTION OF EMBODIMENTS

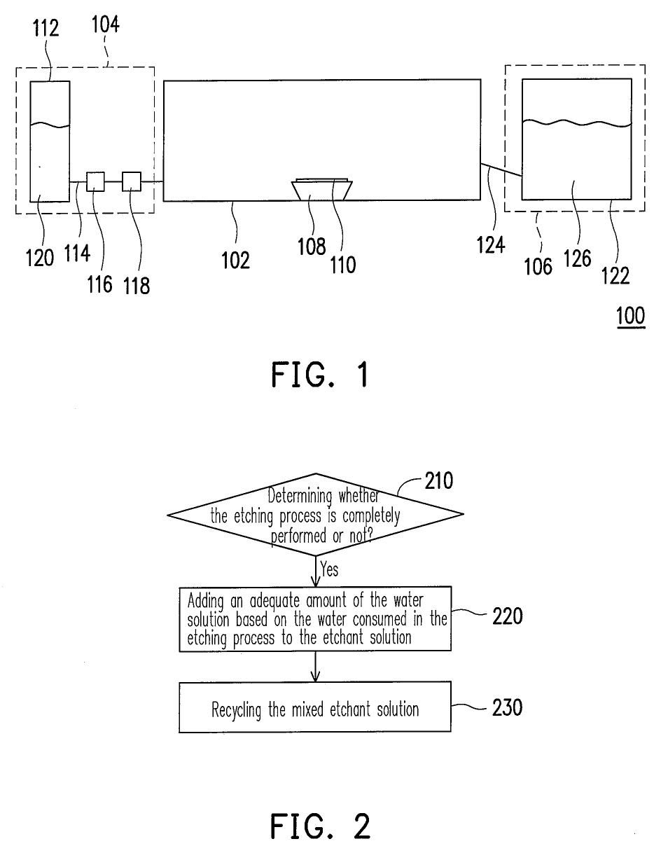

FIG. 1 is a schematic view illustrating an etching apparatus according to an embodiment of the present invention. Referring to FIG. 1, the etching apparatus 100 includes an etching reactor 102, a water solution storage system 104, and an etchant solution storage system 106. The etching apparatus 100 is, for example, model SEZ 4300. Both the water solution storage system 104 and the etchant solution storage system 106 are connected to the etching reactor 102. Here, the etchant solution storage system 106 is used to provide the etchant solution required for etching a wafer to the etching reactor 102. Said etchant solution is necessary for carrying out an etching process. On the other hand, the water solution storage system 104 is used to provide the required water solution 120 to the etching reactor 102. The water solution 120 can be mixed into the recycled etchant solution, so as to maintain the water content of the ecthant solution.

The etching reactor 102 is capable of holding and mounting a wafer 110 with the use of a sucker 108. The water solution storage system 104 includes a water solution storage tank 112, a pipe 114, an air valve 116, and a flow rate controller 118. The water solution storage tank 112 includes the water solution 120 composed of de-ion water, for example. Through the pipe 114, the water solution storage tank 112 is connected to the etching reactor 102 and provides an adequate amount of the water solution to the etching reactor 102 according to the water consumed in the etching process. The air valve 116 is disposed on the pipe 114 to control a flow time thereof. The flow rate controller 118 is disposed on the pipe 114 to control a flow rate of the water solution in the pipe 114. In other words, the amount of water introduced into the etching reactor 102 can be adjusted simply by controlling the air valve 116 and the flow rate controller 118.

In addition, the etchant solution storage system 106 includes an etchant solution storage tank 122 and a recycling pipe 124. The etchant solution storage tank 122 includes an etchant solution 126. The etchant solution 126 is composed of ATMI ST-250, for example. Through the recycling pipe 124, the etchant solution storage tank 122 is connected to the etching reactor 102 for recycling the etchant solution 126.

When the etching process is performed on the wafer 110 in the etching reactor 102, the etchant solution storage system 106 pumps an adequate amount of the etchant solution from the etchant solution storage tank 122 and sprays the etchant solution to the wafer 110, so that the etching process can be performed. During the etching process, the etching apparatus 100 determines a reset time thereof. If the reset time is greater than a predetermined time, it can be deduced that the etching process is completed and a subsequent process can be performed. According to another embodiment of the present invention, the predetermined time can be set as 45 seconds while the time lapse of the etching process is, for example, 90 seconds.

After the completion of the etching process is confirmed, the etching apparatus 100 may remove the residual etchant solution on the wafer 110 through a spin-dry process. In the spin-dry process, the air valve 116 in the water solution storage system 104 is opened, and the water solution is introduced to the etching reactor 102 through the pipe 114 and mixed with the etchant solution to be recycled in the etching reactor 102. During the spin-dry process performed by the etching apparatus 100, the adequate amount of the water solution determined by the flow rate controller 118 is provided to the etching reactor and is mixed with the etchant solution to be recycled, so that the water content of the recycled etchant solution remains constant. According to another embodiment of the present invention, it is for sure that the adequate amount of the water solution can be directly added to the etchant solution 126 after each of the etching process is performed. Thereby, the water content of the etchant solution 126 stays the same.

According to another embodiment of the present invention, given that the etching apparatus 100 is the model SEZ 4300, the reset time can be determined by the time interval within which a reset signal “HOME” is generated with the use of SEZ 4300, so as to make sure whether the etching apparatus is performing the etching process. When the time interval within which the reset signal “HOME” is generated is greater than the predetermined time, it can be deducted that the etching process is carried out by the etching apparatus, and the spin-dry process on the wafer and the recycling process of the etchant solution will be subsequently performed. During the recycling process of the etchant solution, the adequate amount of the water solution may be introduced to the etching reactor 102 by the water solution storage system 104 based on the water consumed in the etching process. The water solution is mixed with the etchant solution to be recycled in the etching reactor 102, so as to keep the water content of the etchant solution 126 at a constant level.

In accordance with different manufacturing conditions, the flow rate set by the flow rate controller 118 can be determined by calculating the water consumption of each wafer after the etching process is performed, and thereby the flow rate is adjusted to an adequate level in compliance with the recycling time. In the present embodiment, each wafer consumes approximately 3.15 cc of water, and the time lapse for performing the spin-dry process is 5 seconds (The etching apparatus of the present embodiment carries out the recycling process of the etchant solution during the spin-dry process). Thus, the flow rate can be set as 3.15 cc per 5 seconds.

The water solution introduced to the etching reactor 102 is mixed with the residual etchant solution 126 in the etching reactor 102, and flows back to the etchant solution storage tank 122 of the etchant solution storage system 106 through the recycling pipe 124 of the etchant solution storage system 106. The chemical life time of the etchant solution 126 is mainly determined by the water content of the etchant solution 126. Therefore, adding the water solution to the etchant solution while the etchant solution 126 is recycled can reduce the water consumption of the etchant solution 126 and prevent the viscosity of the etchant solution 126 from being increased. In the present embodiment, the weight percentage of water in the etchant solution 126 remains within the range of 30% wt˜39% wt by adding the water solution to the etchant solution 126. This leads to an effective extension of the chemical life time of the etchant solution 126 and reduces the manufacturing costs.

The present invention also discloses a method for recycling an etchant solution of a semiconductor processing apparatus. FIG. 2 is a flow chart illustrating the method for recycling the etchant solution according to an embodiment of the present invention. The etching method is adapted to a processing apparatus e.g. said etching apparatus 100 which provides an etchant solution to perform an etching process on a wafer. In the present embodiment, the etching apparatus 100 is taken as an example to illustrate the recycling method of the present embodiment. Please refer to FIG. 1 together with the following description.

The method for recycling the etchant solution according to the present embodiment includes the steps: determining whether the etching process is completely performed by the etching apparatus 100 in Step 210. If the etching process is completed, Step 220 will then be initiated. In Step 220, adding an adequate amount of the water solution based on the water consumed in the etching process to the etchant solution so as to keep the water content of the etchant solution at a constant level. Next, in Step 230, recycling the mixed etchant solution.

According to another embodiment of the present invention, the completion of the etching process can be confirmed by the reset time of the etching apparatus 100 in Step 210. The exemplary etching apparatus model SEZ 4300 generates the reset signal “HOME” after completing any of the processes (e.g. a wafer-cleaning process, the etching process, and the spin-dry process). Thereby, whether the etching process is completely performed by the model SEZ 4300 can be determined by the time interval within which the reset signal “HOME” is generated. In the present embodiment, a predetermined time can be set. When the reset time is greater than the predetermined time, it can be deduced that the etching process is thoroughly carried out by the model SEZ 4300. According to the present embodiment, the predetermined time can be set as 45 seconds while the reset time of the etching process is, for example, 90 seconds. The predetermined time can be set as any value which allows the etching process to be performed, such as 46 seconds, 50 seconds, and so on.

When the etching process is thoroughly carried out by the etching apparatus 100, the spin-dry process on the wafer and the recycling process of the etchant solution will be subsequently performed. Here, in Step 220, the adequate amount of the water solution is added to the etching solution by the etching apparatus 100 based on the water consumed in the etching process. In the present embodiment, if each wafer consumes 3.15 cc of water content of the etchant solution during the etching process, and the time lapse for performing the spin-dry process is 5 seconds (the etching apparatus of the present embodiment carries out the recycling process of the enchant solution during the spin-dry process), the water solution can be added to the etchant solution in Step 220 at the flow rate of 3.15 cc per 5 seconds. Here, if the etchant solution is composed of ATMI ST-250, the amount of the water solution can be calculated by the required viscosity of the etchant solution. For example, the weight percentage of water in the etchant solution remains at 30 wt %˜39% wt. Other details of the method have already been described in the embodiment of FIG. 1 and will not be repeated as they may be deduced by those of ordinary skill in the art according to the disclosure of the present invention.

To sum up, the chemical life time of the etchant solution is mainly determined by the water content of the etchant solution. Thus, introducing the water solution to the etchant solution before recycling the etchant solution can prevent the viscosity of the etchant solution from being increased after the etching process is performed. This leads to an effective extension of the chemical life time of the etchant solution and reduces the manufacturing costs.

Although the present invention has been disclosed above by the preferred embodiments, they are not intended to limit the present invention. Anybody skilled in the art can make some modifications and alteration without departing from the spirit and scope of the present invention. Therefore, the protecting range of the present invention falls in the appended claims.

What is claimed is:

1. A method for recycling an etchant solution of a semiconductor processing apparatus, the method being applied to a processing apparatus which provides an etchant solution and performs an etching process on a wafer, the method comprising:
adding a water solution to the etchant solution for maintaining a water content thereof after the etching process is completed; and
recycling the mixed etchant solution.

2. The method of claim 1, wherein the step of adding the water solution to the etchant solution comprises:
adjusting the amount of the water solution based on the water consumed by the wafer during the etching process.

3. The method of claim 2, wherein the water consumed in the etching process is 3.15 cc per wafer.

4. The method of claim 1, further comprising a spin-dry process for removing residual etchant solution on the wafer after the etching process is completed, a water solution being added to the etchant solution during the spin-dry process.

5. The method of claim 4, wherein the method for removing the residual etchant solution on the wafer comprises a spin-dry method.

6. The method of claim 5, wherein a time lapse of the spin-dry process for removing the residual etchant solution on the wafer is 5 seconds.

7. The method of claim 5, wherein the water solution comprises de-ion water.

8. The method of claim 1, further comprising:
spraying the etchant solution on the wafer to perform the etching process.

9. The method of claim 8, wherein a time lapse of the etching process comprises 90 seconds.

10. The method of claim 1, wherein the etchant solution is composed of ATMI ST-250.

11. The method of claim 1, wherein the process of adding the water solution to the etchant solution for maintaining the water content thereof comprises a step of maintaining a weight percentage of water in the etchant solution at 30 wt %˜39% wt.

12. The method of claim 1, wherein the semiconductor processing apparatus comprises an etching apparatus.

13. The method of claim 12, wherein the etching apparatus includes model SEZ 4300.

14. The method of claim 1, wherein the step of adding the water solution to the etchant solution for maintaining the water content thereof further comprises:
determining a reset time of the semiconductor processing apparatus, the etching process being completed by the semiconductor processing apparatus when the reset time is greater than a predetermined time.

15. The method of claim 14, wherein the predetermined time is 45 seconds.

16. An etching apparatus, comprising:
an etching reactor;
an etchant solution storage system connected to the etching reactor for providing an etchant solution thereto; and
a water solution storage system connected to the etching reactor,
wherein the water solution storage system actuates a step of adding a water solution to the etchant solution for maintaining a water content thereof when the etchant solution is recycled by the etching apparatus.

17. The etching apparatus of claim 16, wherein the water solution storage system comprises:
a water solution storage tank having a water solution therein;
a pipe connected to the water solution storage tank and the etching reactor for introducing the water solution to the etching reactor;
an air valve disposed on the pipe for controlling a flow time of the pipe; and
a flow rate controller disposed on the pipe for controlling a flow rate of the water solution,
wherein the air valve is open for the water solution storage system to add a water solution to the etchant solution when the etchant solution is recycled by the etching apparatus.

18. The etching apparatus of claim 16, wherein the water solution comprises de-ion water.

19. The etching apparatus of claim 16, wherein the etching reactor comprises a sucker disposed therein.

20. The etching apparatus of claim 16, wherein the etchant solution is composed of ATMI ST-250.

21. The etching apparatus of claim 16, wherein the process of adding the water solution to the etchant solution for maintaining the water content thereof comprises a step of maintaining a weight percentage of water in the etchant solution at 30 wt %˜39% wt.

22. The etching apparatus of claim 16, wherein the etching apparatus includes model SEZ 4300.

23. The etching apparatus of claim 16, wherein the step of adding the water solution to the etchant solution for maintaining the water content thereof further comprises:
determining a reset time of the etching apparatus, the etching process being completed by the etching apparatus when the reset time is greater than a predetermined time.

24. The etching apparatus of claim 23, wherein the predetermined time is 45 seconds.
